(19) United States
(12) Patent Application Publication
(10) Pub. No.: US 2006/0055783 A1
(43) Pub. Date: Mar. 16, 2006

(54) Image processing device, its control method and control program

(75) Inventors: Michihiro Kawamura, Kanagawa (JP); Yukiko Kikuchi, Kanagawa (JP); Masaki Kuroda, Kanagawa (JP); Yoshihiro Sekine, Kanagawa (JP); Akihito Toyoda, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/043,414

(22) Filed: Jan. 27, 2005

(30) Foreign Application Priority Data
Sep. 15, 2004 (JP) 2004-268445

(51) Int. Cl. H04N 5/225

(52) U.S. Cl. 348/207.2

(57) ABSTRACT

An image processing device which executes prescribed processing according to a key operation on an operation panel, comprising an operating state detector which detects an operating state of the device, a key operation detector which detects the key operation on the operation panel, and a notifying unit which notifies the operation state of the device detected by the operating state detector according to a detection output by the key operation detector.

### BACKGROUND OF THE INVENTION

1. Field of the Invention

The present invention relates to an image processing device for performing prescribed processing according to a key operation on an operation panel and its control method and program, and more particularly to an image processing device, which detects a key operation and notifies an operating state of the device, and its control method and program.

2. Description of the Related Art

In recent years, various types of image processing devices such as copy machines and multifunctional devices have been proposed considering a universal design (design of products, services and environments which are user friendly and can be used by people as many as possible regardless of a difference in age, sex or race and disabled or not).

Among such image processing devices, it is known to provide a technology that the state of a printer and its change are notified by a sound without depending on a small and difficult-to-see operation panel of the printer.

Furthermore, it is known to provide a technology that, when a disabled person uses the operation panel, operation functions (various settings for a totally blind mode, a weak sight mode, a color-blind mode, an impaired hearing mode, a bradykinesia mode and a wheelchair mode) for the disabled people are applied to the operation panel.

Conventionally, when a visually-impaired person (who is totally blind, weak sighted or decreased sighted) wants to use a multifunctional device which is provided with various functions of a copy, a facsimile and a scanner, there is no response even if any of buttons disposed on the operation panel is pushed specially in a power saving mode because the operation panel is not energized. Therefore, it is hard for the visually-impaired person to know the state of the multifunctional device.

The present invention has been made in view of the above circumstances and provides an image processing device, which detects a key operation and notifies an operating state of the device, and its control method and program.

### SUMMARY OF THE INVENTION

An aspect of the present invention provides an image processing device for executing prescribed processing according to a key operation on an operation panel, comprising: an operating state detector which detects an operating state of the device; a key operation detector which detects the key operation on the operation panel; and a notifying unit which notifies the operation state of the device detected by the operating state detector according to a detection output of the key operationdetector.

A further aspect of the present invention provides a control method for an image processing device to perform prescribed processing according to a key operation on an operation panel, comprising: detecting an operating state of the device by an operating state detector; detecting the key operation on the operation panel by a key operation detector; and notifying the operating state of the device detected by the operating state detector based on a detection output from the key operation detector by a notifying unit.

A still further aspect of the present invention provides a control program to cause a computer to execute processing of an image processing device, which executes prescribed processing according to a key operation on an operation panel, comprising: an operating state detecting step for detecting an operating state of the device; a key operation detecting step for detecting the key operation on the operation panel; and a notifying step for notifying the operating state of the device detected in the operating state detecting step according to a detection output by the key operation detecting step.

According to the present invention, it is configured that, when a key operation is received, the current state of the device is detected, and the operating state of the device is voice guided according to the detection, so that it is particularly effective for the visually-impaired persons.

### BRIEF DESCRIPTION OF THE DRAWINGS

Embodiments of the present invention will be described in detail based on the following figures, wherein:

FIG. 1 is a block view showing a schematic structure of a multifunctional device 1 to which the image processing device according to the present invention is applied;

FIG. 2 is a view showing an example of the entire layout of an operation panel 10 shown in FIG. 1;

FIG. 3 is a flow chart illustrating an operation of control processing of the multifunctional device 1 shown in FIG. 1;

FIG. 4 is a block view showing a schematic structure of the multifunctional device 1 according to Example 2;

FIG. 5 is a view showing an example of a screen layout of the operation panel 10 according to Example 2;

FIG. 6 is a flow chart illustrating an operation of control processing of the multifunctional device 1 according to Example 2 (autoclear timer effective);

FIG. 7 is a flow chart illustrating an operation of control processing of the multifunctional device 1 according to Example 2 (autoclear timer ineffective);

FIG. 8 is a block view showing a schematic structure of the multifunctional device 1 and a visually-impaired person dedicated terminal 50 according to Example 3;

FIG. 9 is a view showing a list of example keyboard specifications of the visually-impaired person dedicated terminal 50;

FIG. 10 is a view showing an example of an application screen displayed on the visually-impaired person dedicated terminal 50;

FIG. 11 is a sequence chart showing a flow of processing between the multifunctional device 1 and the visually-impaired person dedicated terminal 50 according to Example 3; and

FIG. 12 is a view showing an example of the entire layout of the operation panel 10 according to Example 3.

### DETAILED DESCRIPTION OF THE INVENTION

Examples of the image processing device and its control method and program according to the present invention will be described in detail with reference to the accompanying drawings.

### EXAMPLE 1

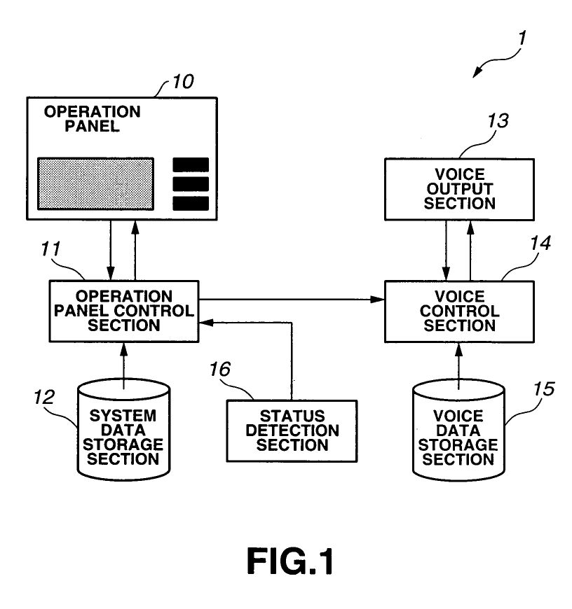

FIG. 1 is a block view showing a schematic structure of the multifunctional device 1 to which the image processing device according to the present invention is applied. Here, only the components according to the present invention are described.

In FIG. 1, the multifunctional device 1 is comprised of an operation panel 10, an operation panel control section 11, a system data storage section 12, a voice output section 13, a voice control section 14, a voice data storage section 15 and a status detection section 16 as various processing function sections.

The operation panel 10 is a user interface having an input device such as a touch panel and operation (hard) buttons, and a display device such as LED (Light Emitting Diode) and LCD (Liquid Crystal Display). If there is input from the input device, the operation panel 10 can detect the input even after the multifunctional device 1 is switched to a power saving mode.

The operation panel control section 11 is a processing section for controlling the above-described operation panel 10. For example, it controls to display various types of screens stored in the system data storage section 12 onto the operation panel 10. When a user uses the input device to input a user instruction on the screen, the processing based on the user instruction is performed in cooperation with the various processing function sections.

The system data storage section 12 holds system data related to the operation of the multifunctional device 1 as a whole. For example, it stores operation information about whether voice is output from the voice output section 13 described later.

The voice output section 13 is a loud speaker mounted on the device body. For example, if certain key input is made through the operation panel 10 during the power saving mode, a voice message “Power saving mode now. If you want to cancel the power saving mode, push the power saving button.” is output. The voice output section 13 may be mounted on the operation panel 10.

The voice control section 14 is a processing section for controlling the above-described voice output section 13. Specifically, the voice control section 14 receives a voice guide output instruction notice from the operation panel control section 11, obtains pertinent data from various types of voice data stored in the voice data storage section 15 and outputs voice guide from the voice output section 13.

The voice data storage section 15 is a storage device for storing various types of voice data for voice output from the voice output section 13 as described above.

The status detection section 16 is a processing section for detecting the current state of the multifunctional device 1. Specifically, it detects the state of the device, such as initializing, starting up, standing by, power saving, operating, or the like, and notifies the detected result to the operation panel control section 11. The various processing function sections of the multifunctional device 1 according to the present invention were described above.

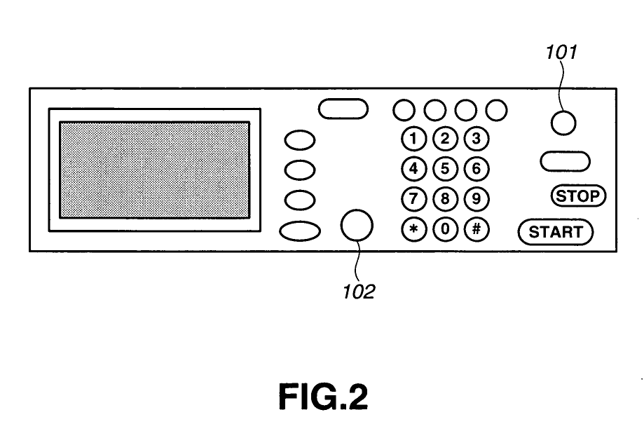

FIG. 2 is a view showing an example of the entire layout of the operation panel 10 shown in FIG. 1.

As shown in FIG. 2, the input device (operation buttons) of the operation panel 10 includes a power saving button 101 and a voice guide button 102. The power saving button 101 is a button for entering a power saving mode or canceling that mode, and the voice guide button 102 is a button for setting whether a voice guide is conducted or not.

When the voice guide button 102 is pushed to enable the voice guide, the voice guide enabled is set in the voice guide output parameter which is held by the above-described system data storage section 12. When the voice guide button 102 is pushed again, the voice guide output is disabled.

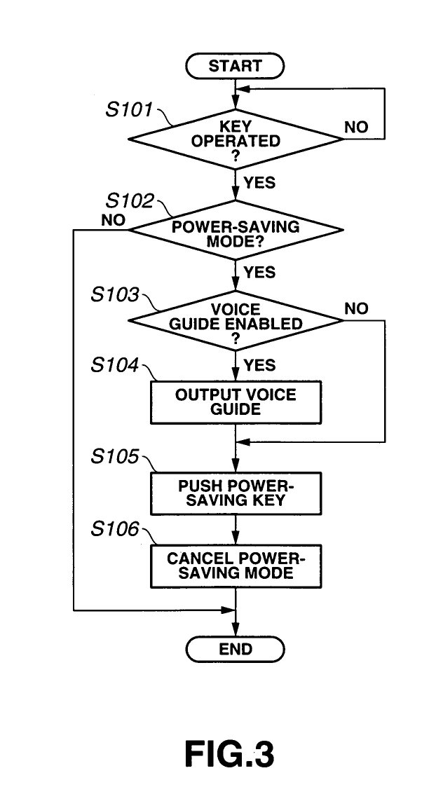

FIG. 3 is a flow chart illustrating an operation of control processing by the multifunctional device 1 shown in FIG. 1. Here, description will be made on the assumption that the status detection section 16 has detected the power saving mode.

In FIG. 3, this control processing is started when a certain input operation (key operation) is made by the input device disposed on the operation panel 10 (YES in step S101).

When the control processing is started, it is judged whether the power saving mode is on or not (step S102). This processing detects the state of the multifunctional device 1 by the status detection section 16 and judges according to the detected result whether the power saving mode is on or not.

When it is judged as a result of the detection that the multifunctional device 1 is in a state other than the power saving mode (NO in step S102), this control processing is terminated. But, when it is judged that the multifunctional device 1 is in the power saving mode (YES in step S102), it is judged whether voice guide output is then performed (step S103). This processing refers to the voice guide output parameter which is previously set in the system data storage section 12 to judge whether the voice guide output is performed or not.

Here, where the voice guide is disabled in the system data storage section 12 (NO in step S103), the multifunctional device 1 is standing by until the power saving key is pushed, but where the voice guide is enabled in the system data storage section 12 (YES in step S103), a voice guide output instruction notice is given from the operation panel control section 11 to the voice control section 14. Upon receiving the output instruction notice, the voice control section 14 obtains pertinent data from the various types of voice data stored in the voice data storage section 15 and outputs the voice guide from the voice output section 13 (step S104).

For example, this voice guide outputs, “Power saving mode now. If you want to cancel the power saving mode, push the power saving key.”

The user having recognized from the voice guide that the multifunctional device 1 is in the power saving mode pushes the power saving key according to the voice guide (step S105) to cancel the power saving mode (step S106). After the power saving key is pushed and the voice guide “Power saving mode is being cancelled.” is output from the voice output section 13, the power saving mode is cancelled, and a voice guide for guiding a power-saving mode canceling operation, “Power saving mode was cancelled.” is output.

As described above, the present invention is configured so that, when the key operation is accepted, the current state of the device is detected, and the operating state of the device is voice guided according to the detection. Therefore, it is effective particularly for visually-impaired persons and can enhance convenience.

It was described in the above-described example that the device is in the power saving mode. But, in addition, it may be configured to perform voice guide “Starting up. Please wait a minute.” when the key operation is made during, for example, starting up. Typical embodiments applying the present invention will be described in the following Examples 2 and 3.

### EXAMPLE 2

It was described in Example 1 that it was detected by the status detection section 16 that the power saving mode was on. It will be described in Example 2 that a print permit timer is disposed to make it possible to detect by the status detection section 16 that the print permit timer is on.

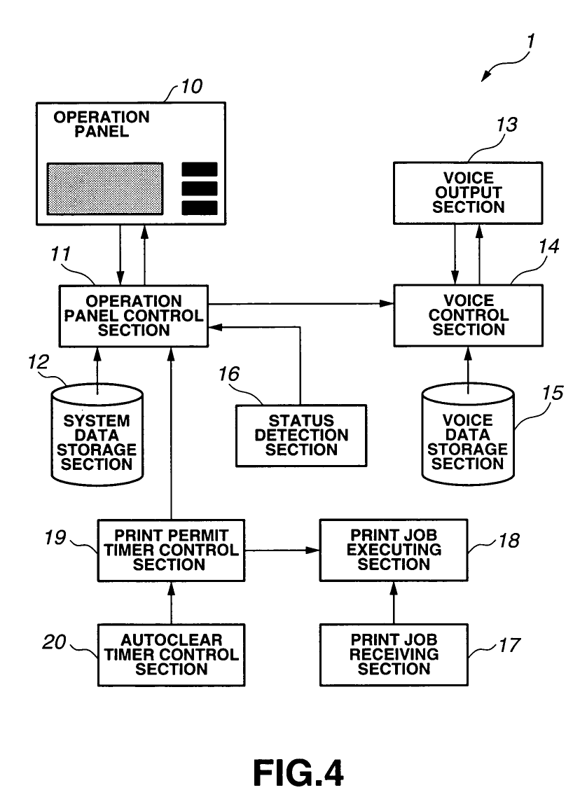

FIG. 4 is a block view showing a schematic structure of the multifunctional device 1 according to Example 2. It is to be understood that the portions allotted with the same reference numerals as those in FIG. 1 described in Example 1 operate substantially in the same manner.

In FIG. 4, the multifunctional device 1 is comprised of a print job receiving section 17, a print job executing section 18, a print permit timer control section 19 and an autoclear timer control section 20 in addition to the structure of Example 1.

The print job receiving section 17 is a processing section which receives and manages a print job from a person other than the operator of the operation panel 10. Specifically, it receives a print job through a network such as a public line, LAN (Local Area Network) or WAN (Wide Area Network) and manages the received job.

The print job executing section 18 is a processing section for executing the print job received by the print job receiving section 17.

The print permit timer control section 19 is a processing section which controls the print permit timer to suspend the execution of the print job received by the print job receiving section 17. Specifically, if a print job is received from a person other than the operator of the operation panel 10 during the operation of the operation panel 10, the print permit timer is started to inhibit the execution of the print job by the print job executing section 18. Meanwhile, when the remaining time of the print permit timer expires, the print job execution by the print job executing section 18 is allowed. In other words, the operator of the operation panel 10 can exclusively use the multifunctional device 1 while the print permit timer is on.

The remaining time of the print permit timer is noticed from the print permit timer control section 19 to the operation panel control section 11. The operation panel control section 11 recognizes from the detected result by the status detection section 16 that the print permit timer is on and controls to display the print permit timer on the operation panel 10. At this time, the operation panel control section 11 cooperates with the voice control section 14 to notify the remaining time of the print permit timer to the user by the voice guide too.

The autoclear timer control section 20 controls the autoclear timer and cancels various settings when the remaining time of the autoclear timer expires. For example, when the above-described print permit timer is stopped according to the user instruction, no print job from a person other than the operator is executed at all, and a user other than the operator is made to wait for the execution of a job for a long time. In such a case, when the remaining time of the autoclear timer expires, the print job execution prohibition setting by the print permit timer control section 19 is cancelled. After the cancellation, the print job is executed by the print job executing section 18.

And, the autoclear timer is started at the same time when the print permit timer is started and not shown on the operation panel 10. Therefore, the autoclear timer is desirably set to a time longer than the set time of the print permit timer. If the set time of the autoclear timer is shorter than that of the print permit timer, there is a possibility that the print job is executed even if the remaining time of the print permit timer is shown on the operation panel 10.

Therefore, if the automatic execution of the print job is not desired, it is also possible to set so that the timer control is not executed by the autoclear timer control section 20. The various processing function sections of the multifunctional device 1 according to Example 2 were described above.

In the above description about the print permit timer start conditions, it was assumed that the operation panel 10 was being operated. But, it is not exclusive but it is satisfactory when it is an event that the operation of the multifunctional device 1 can be recognized. For example, the operation includes an operation of setting paper in the paper feed tray of the multifunctional device 1, an operation of opening and closing a document feeder, and the like.

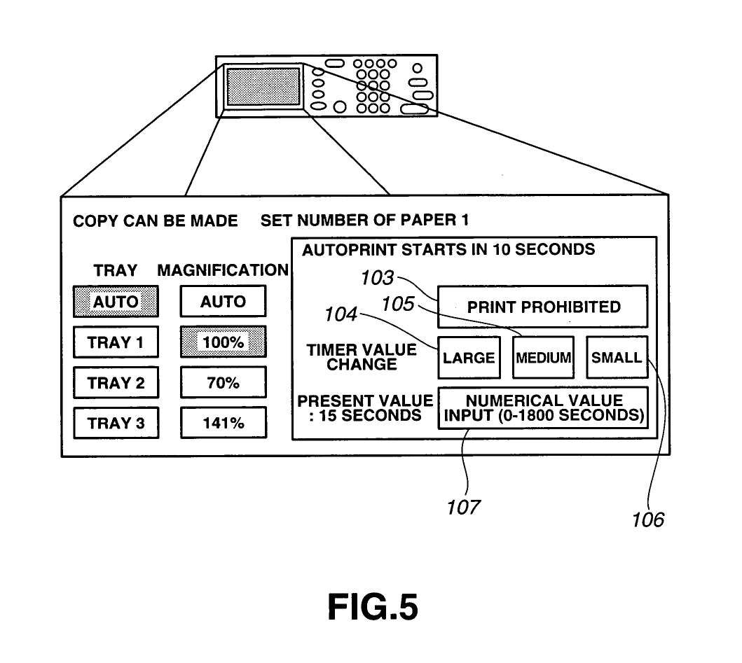

FIG. 5 is a view showing an example of the screen layout of the operation panel 10 according to Example 2. Here, what is shown on the screen when a print job is received from a person other than the operator and the print permit timer is started during the operation of the operation panel 10 will be described.

As shown in FIG. 5, when the print permit timer is started, a message “It is ten minutes before autoprint is started.” and the remaining time of the print permit timer is displayed. A print prohibition button 103, a large button 104, a medium button 105 and a small button 106 for timer value change and a numerical value input button 107 are disposed.

When the print prohibition button 103 is pushed, the print permit timer is stopped, a message “Printing is prohibited.” is displayed, and the screen is switched to display the print start button. When the print start button is pushed, the execution of a print job by a person other than the operator is started, and the screen is switched again to display the print prohibition button.

The large button 104, medium button 105 and small button 106 for timer change values are buttons for extending (resetting) the print permit timer, and a predetermined timer value is allotted to them. For example, it is set such that the large button 104 is 600 seconds, the medium button 105 is 120 seconds and the small button 106 is 60 seconds.

When the numerical value input button 107 is pushed, a desired timer value can be input by ten keys disposed in the operation buttons.

When the screen is displayed, the remaining time of the print permit timer is also voice output by the voice output section 13. For example, a message “It is ten minutes before autoprint is started.” is voice output. Information such as a setting to start voice output if the remaining time is less than 60 seconds, a setting to perform voice output at five-second intervals and the like is previously set in the system data storage section 12.

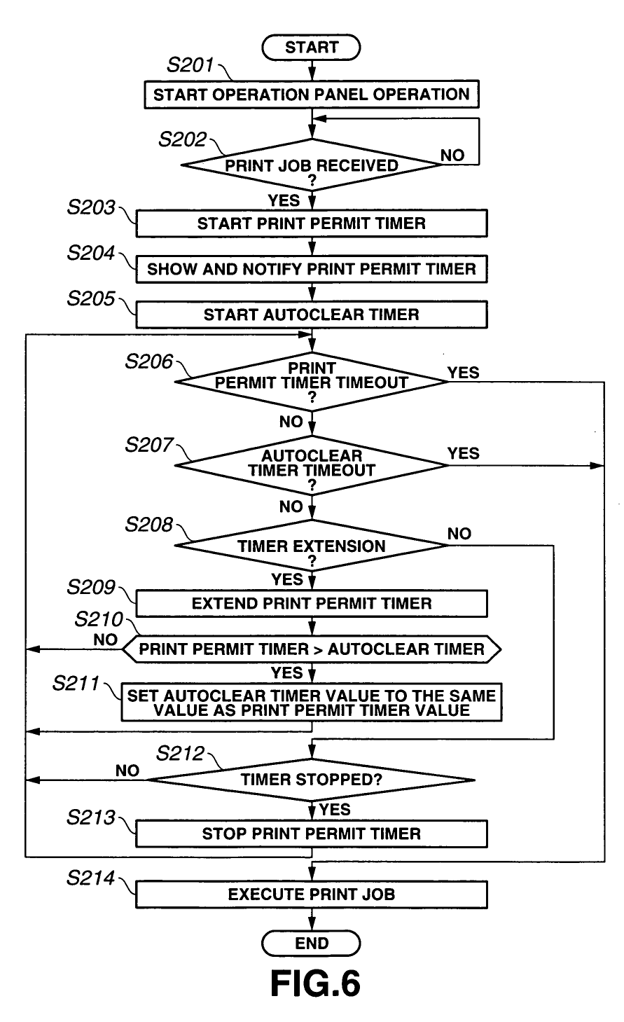

FIG. 6 is a flow chart illustrating the operation of control processing by the multifunctional device 1 according to Example 2. Here, it will be described that the autoclear timer is enabled so as to make autooutput even if in the print prohibition condition.

In FIG. 6, this control processing is started when a certain input operation (key operation) is made by the input device disposed on the operation panel 10 (step S201) and a print job is received by the print job receiving section 17 from a person other than the operator of the operation panel 10 (YES in step S202).

When the control processing is started, the print permit timer is started by the print permit timer control section 19 (step S203).

When the print permit timer is started, the remaining time of the print permit timer is noticed from the print permit timer control section 19 to the operation panel control section 11. The operation panel control section 11 recognizes based on the detected result from the status detection section 16 that the print permit timer is on and shows a screen including the print permit timer shown in FIG. 5 on the operation panel 10. At this time, the operation panel control section 11 cooperates with the voice control section 14 to also notify the remaining time of the print permit timer to the user by the voice guide (step S204).

And, when the print permit timer is started, the autoclear timer is started by the autoclear timer control section 20 (step S205).

The control processing by the multifunctional device 1 is continued until the remaining time of the print permit timer started in step S203 or that of the autoclear timer started in step S205 expires. Here, when the remaining time of either of the timers has expired (YES in step S206 or YES in step S207), the print job is executed by the print job executing section 18 (step S214), and the control processing is terminated.

When the remaining time of the print permit timer and that of the autoclear timer are still remaining (NO in step S206, and then NO in step S207), the user inputs a user instruction on a screen including the print permit timer shown in FIG. 5 displayed on the screen in step S204. Specifically, the multifunctional device 1 stands by until any of the print prohibition button 103, the timer value change buttons (large button 104, medium button 105, small button 106) and the numerical value input button 107 is pushed (step S208 and step S212).

Here, if any of the timer value change buttons (large button 104, medium button 105, small button 106) and the numerical value input button 107 is pushed (YES in step S208), the print permit timer control section 19 extends the print permit timer according to the input button (step S209). For example, if the large button 104 for changing the timer value is pushed, the print permit timer value is set to be extended by several seconds which are previously allotted to the large button 104.

After the extension (resetting) of the print permit timer is set, it is judged whether the extension set print permit timer is set to a value larger than the remaining time of the autoclear timer (step S210). It is because if the remaining time of the print permit timer becomes larger than that of the autoclear timer, there is a possibility that the print job is executed by the autoclear timer not shown on the screen regardless of the remaining of the remaining time of the print permit timer.

As a result of the judging processing, if the remaining time of the print permit timer is smaller than that of the autoclear timer (NO in step S210), the process returns to step S206 and the remaining time of the timer is judged again. If the remaining time of the print permit timer is larger than that of the autoclear timer (YES in step S210), the remaining time of the autoclear timer is set to the same as that of the print permit timer (step S211), then the process returns to step S206, and the remaining time of the timer is judged again.

When the user pushes the print prohibition button 103 on the screen including the print permit timer shown in FIG. 5 (NO in step S208 and then YES in step S212), the print permit timer control section 19 stops the print permit timer (step S213). In this case, the remaining time of the autoclear timer expires and the print job execution prohibition setting by the print permit timer control section 19 is cancelled.

As described above, when the print permit timer and the autoclear timer are used, even if the print permit timer is stopped according to the user instruction, the print job execution prohibition setting made by the print permit timer control section 19 is cancelled by the autoclear timer, and the print job is executed. Therefore, it is prevented that a user other than the operator is made to wait for the execution of the job for a long time because of omission of the prohibition canceling operation by the operator of the operation panel 10.

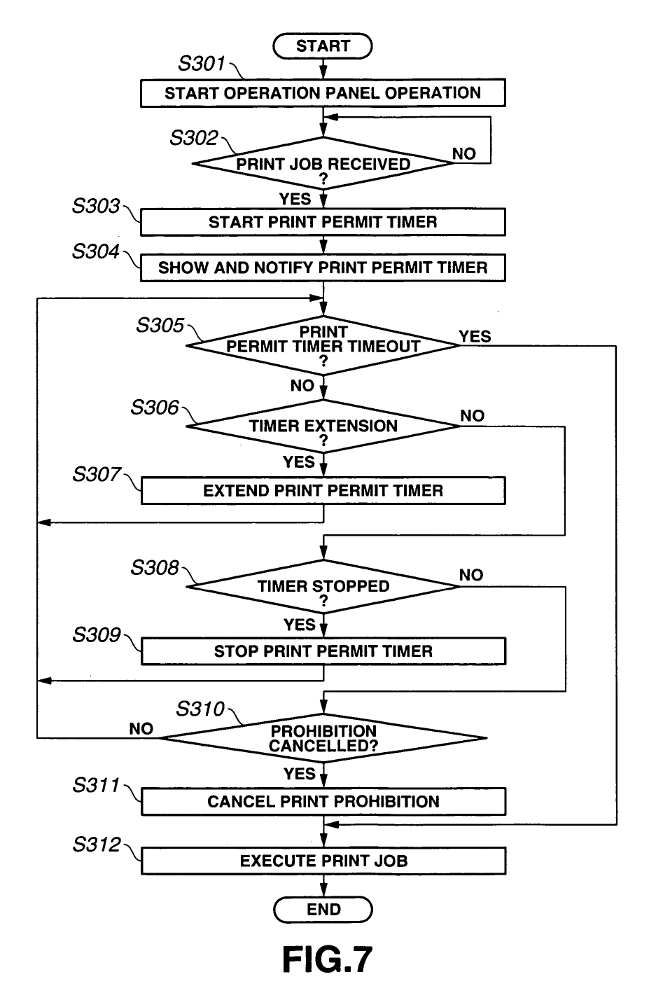

FIG. 7 is a flow chart illustrating the operation of the control processing by the multifunctional device 1 according to Example 2. Here, it will be described that the autoclear timer is disabled, and the print prohibition condition is manually cancelled by the user.

In FIG. 7, the control processing is started when a certain input operation (key operation) is conducted by the input device disposed on the operation panel 10 (step S301), and the print job receiving section 17 receives the print job from a person other than the operator of the operation panel 10 (YES in step S302).

When the control processing is started, the print permit timer is first started by the print permit timer control section 19 (step S303).

When the print permit timer is started, the remaining time of the print permit timer is noticed from the print permit timer control section 19 to the operation panel control section 11. The operation panel control section 11 recognizes based on the detected result from the status detection section 16 that the print permit timer is on and displays a screen including the print permit timer shown in FIG. 5 on the operation panel 10. At this time, the operation panel control section 11 cooperates with the voice control section 14 and notices the remaining time of the print permit timer to the user by the voice guide, too (step S304).

The control processing by the multifunctional device 1 is continued until the remaining time of the print permit timer started in step S303 expires. Here, when the remaining time of the print permit timer expires (YES in step S305), the print job is executed by the print job executing section 18 (step S312), and the control processing is terminated.

If there is still the remaining time of the print permit timer (NO in step S305), the user inputs a user instruction on the screen including the print permit timer shown in FIG. 5 displayed on the screen in step S304. In other words, the multifunctional device 1 stands by until any of the print prohibition button 103, the timer value change buttons (large button 104, medium button 105 and small button 106), the numerical value input button 107 is pushed (step S306, step S308 and step S310). As described above, when the print prohibition button 103 is pushed, print job execution prohibition setting is performed, and the screen is switched to show the print start button 103. In that case, when the print start button 103 is pushed, the print job execution prohibition setting is cancelled, and the screen is switched to show the print prohibition button 103.

Here, when any of the timer value change buttons (large button 104, medium button 105 and small button 106) and the numerical value input button 107 is pushed (YES in step S306), the print permit timer control section 19 extends the print permit timer according to the input button (step S309). For example, when the large button 104 for the timer value change is pushed, the print permit timer value is set to the extension by several seconds previously allotted to the large button 104.

When the user pushes the print prohibition button 103 on the screen including the print permit timer shown in FIG. 5 (NO in step S306 and then YES in step S308), the print permit timer control section 19 stops the print permit timer (step S309). At that time, the screen of the print prohibition button 103 is switched to show a print start button 103.

With the print permit timer stopped in step S309, when the print start button 103 is pushed on the screen including the print permit timer shown in FIG. 5 (NO in step S306, then NO in step S308, and YES in step S310), the print job execution prohibition setting by the print job executing section 18 is cancelled (step S311), the print job is executed by the print job executing section 18 (step S312), and this control processing is terminated. At that time, the screen of the print start button 103 is switched to show the print prohibition button 103.

As described above, when only the print permit timer is used, the print job is not executed automatically even if the print permit timer is stopped, and the operator of the operation panel 10 can operate the job without worrying with no temporal restriction.

As described above, Example 2 disposes in addition to the control processing in Example 1 the print permit timer (timer for prohibition of the execution of the print job by a person other than the operator of the operation panel 10) to configure so as to detect by the status detection section 16 that the print permit timer is on. Therefore, the display of the remaining time of the print permit timer and the voice guide output can be made, so that it is convenient for visually-impaired persons, and convenience can be improved.

The operation time can be extended easily because the button capable of easily extending (resetting) the timer is disposed in the screen displaying the remaining time of the print permit timer, and the operator can be free from feeling insecure because of the expiration of the remaining time of the timer, and the operator can operate the operation panel 10 without worrying.

### EXAMPLE 3

It was described in Example 1 that it was detected by the status detection section 16 that the power saving mode was on. It will be described in Example 3 that it can be detected by the status detection section 16 that a visually-impaired person is operating (voice guidance state).

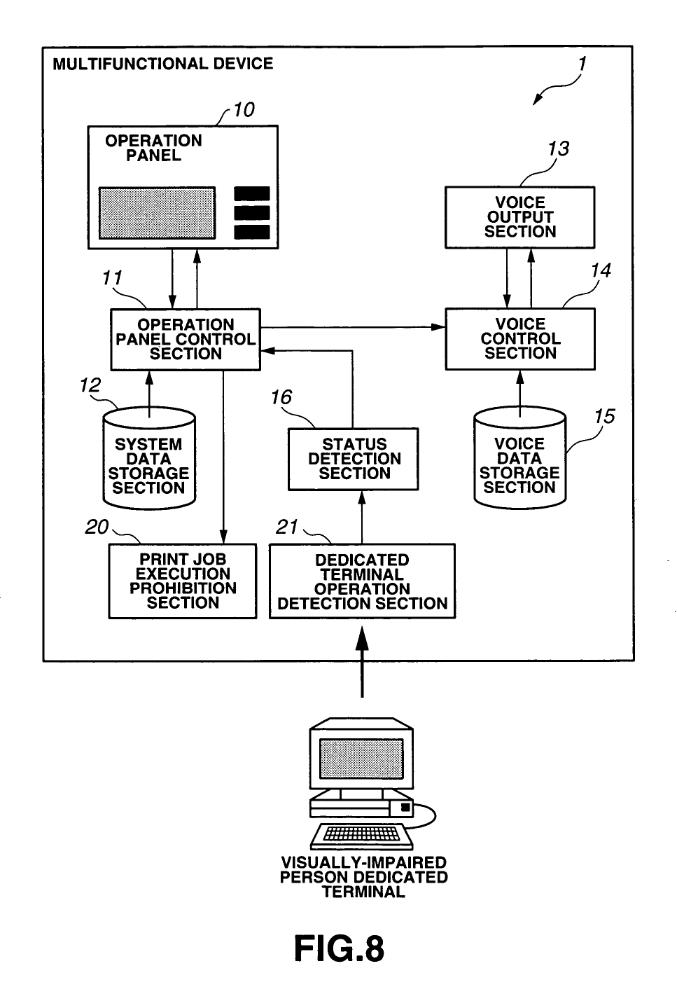

FIG. 8 is a block view showing a schematic structure of the multifunctional device 1 and a visually-impaired person dedicated terminal 50 according to Example 3. It is to be understood that the portions allotted with the same reference numerals as those in FIG. 1 described in Example 1 operate substantially in the same manner.

In FIG. 8, the multifunctional device 1 is connected to the visually-impaired person dedicated terminal 50 by USB (Universal Serial Bus) or the like so as to be mutually communicable. It can also be configured to connect by a mode other than the USB if the functions of the present invention can be executed.

Here, the multifunctional device 1 is comprised of a dedicated terminal operation detection section 21 and a print job execution prohibition section 22 in addition to the structure of Example 1.

The dedicated terminal operation detection section 21 is a processing section which detects an input operation from the visually-impaired person dedicated terminal 50 described later. Specifically, it detects the input operation from the visually-impaired person dedicated terminal 50 and notices the detection to the status detection section 16. Upon receiving the notice, the status detection section 16 detects the current state of the device that it is being operated by the visually-impaired person.

The operation panel control section 11 recognizes based on the detected result from the status detection section 16 that the visually-impaired person is operating and prohibits the input through the operation panel 10. And, it is noticed to the print job execution prohibition section 22 that the visually-impaired person is operating.

The print job execution prohibition section 22 receives from the operation panel control section 11 that the visually-impaired person is operating and prohibits the execution of the print job involving the paper ejection processing. But, the print job from the visually-impaired person dedicated terminal 50 is executed.

To prevent a visually-impaired person from confusing as a result of mixing of paper output as a result of the operation by the visually-impaired person and paper output by a user other than the visually-impaired person, the print job execution prohibition section 22 prohibits the execution of the print job involving the paper ejection processing by the user other than the visually-impaired person when the visually-impaired person is operating.

Therefore, where the multifunctional device 1 has two or more output trays and one of them is determined as a paper ejection destination for the visually-impaired person dedicated terminal 50, the execution of the print job involving the paper ejection to that output tray is prohibited, but it may be determined so that the execution of the print job to discharge to another output tray is not prohibited.

Similarly, if a user other than the visually-impaired persons executes the print job (e.g., scanner processing and facsimile processing) not involving the paper ejection processing, it may be determined to execute the print job even if the visually-impaired person is operating. In that case, if the visually-impaired person copies from the visually-impaired person dedicated terminal 50, the print job is executed by receiving the input through the operation panel 10 related to the scanner processing and facsimile processing by the multifunctional device 1.

Then, the visually-impaired person dedicated terminal 50 is a personal computer or the like which is operated by the visually-impaired persons and comprised of an operation section such as a keyboard for inputting various kinds of data about the execution of the print job and a display section such as a display for displaying the operation screen and the like.

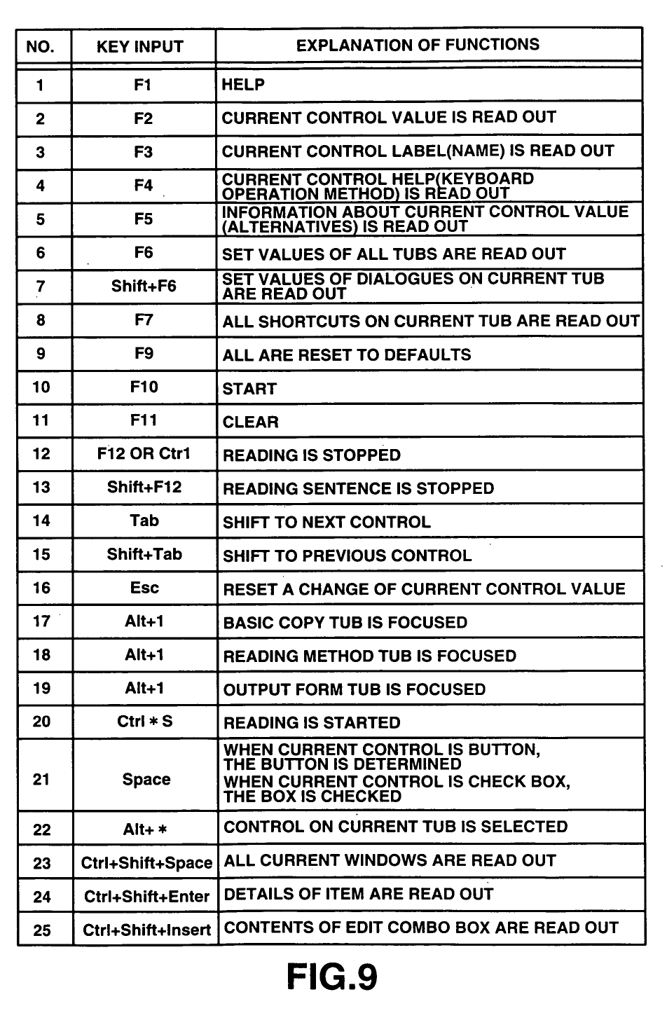

The keyboard as the operation section is designed considering the operation by the visually-impaired persons, and the key operation is realized with, for example, the keyboard specifications as shown in FIG. 9. For example, when “F2” is clicked on the keyboard, the current set value is voice output.

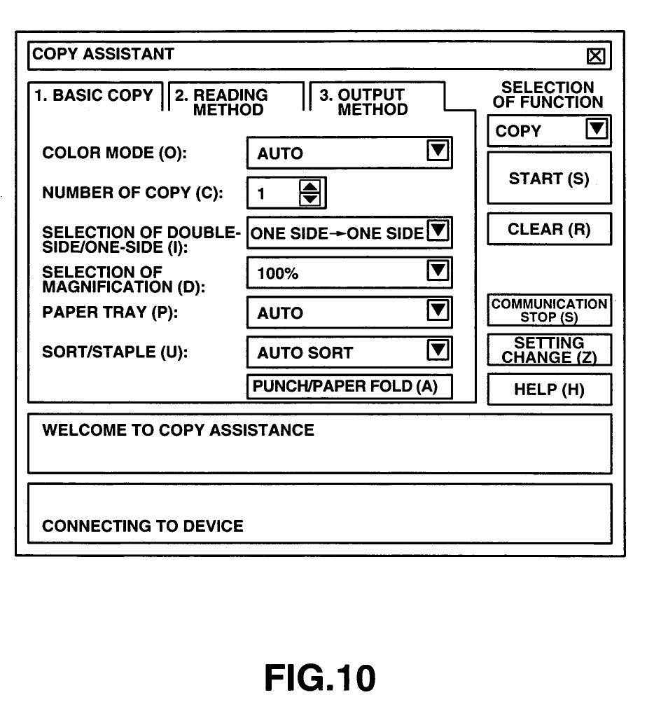

The display as the display section shows the application screen as shown in FIG. 10, and the visually-impaired person inputs various kinds of data about the execution of a job according to the screen and the voice announce.

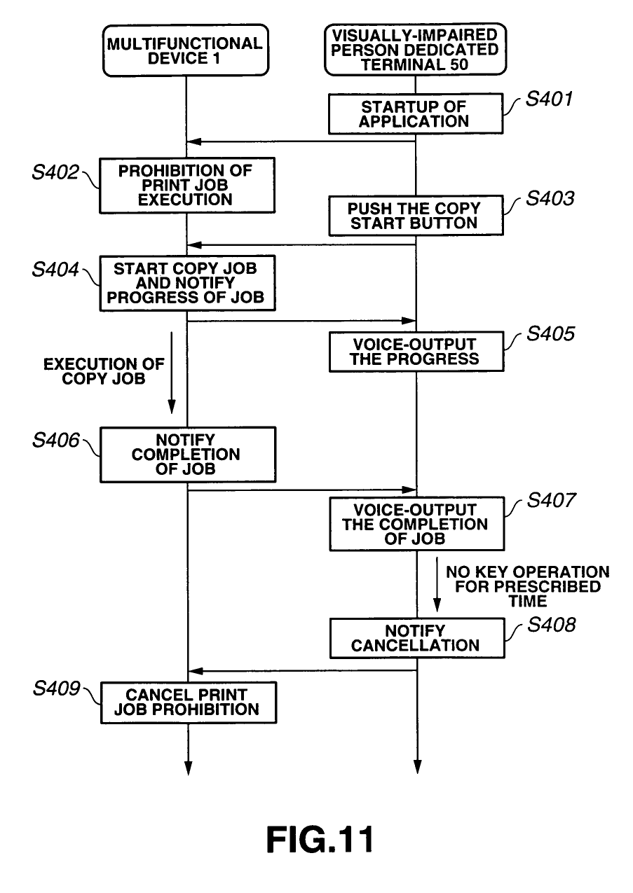

FIG. 11 is a sequence chart showing a flow of processing between the multifunctional device 1 and the visually-impaired person dedicated terminal 50 according to Example 3. Here, the execution of copy processing from the visually-impaired person dedicated terminal 50 will be described.

First, when the user such as a visually-impaired person activates the application from the visually-impaired person dedicated terminal 50, an activation notice is transmitted to the multifunctional device 1 (step S401). Here, the activation of the application will be described, but a certain input operation may be made after the activation of the application.

The multifunctional device 1 having received the startup notice detects the activation of the application on the visually-impaired person dedicated terminal 50 by the dedicated terminal operation detection section 21 and notices the detection to the status detection section 16. The status detection section 16 having received the notice detects the current state of the device that it is being operated by the visually-impaired person. According to the detection, the operation panel control section 11 prohibits the input operation from the operation panel 10, and the print job execution prohibition section 22 prohibits the execution of the print job from other than the visually-impaired person dedicated terminal 50 (step S402).

Here, the user such as the visually-impaired person operates the visually-impaired person dedicated terminal 50 to set a job according to the voice announce. After completing the operation, the user pushes the copy start button, and a job start notice is sent to the multifunctional device 1 (step S403).

Upon receiving the job start notice, the multifunctional device 1 starts a copy job and notices the progress of the job to the visually-impaired person dedicated terminal 50 as appropriate (step S404). According to the notice, the visually-impaired person dedicated terminal 50 executes voice output to notice the progress of the job to the user (step S405).

The multifunctional device 1 completes the copy job, and a copy job completion notice is sent to the multifunctional device 1 (step S406). When the notice is sent, the visually-impaired person dedicated terminal 50 makes voice output about the completion of the copy job to the user (step S407).

Then, if there is no key operation or the like on the visually-impaired person dedicated terminal 50 for a prescribed time, a cancellation notice is transmitted from the visually-impaired person dedicated terminal 50 to the multifunctional device 1 (step S408). The multifunctional device 1 having received the cancellation notice cancels the input operation prohibition from the operation panel 10 and also cancels the print job execution prohibition.

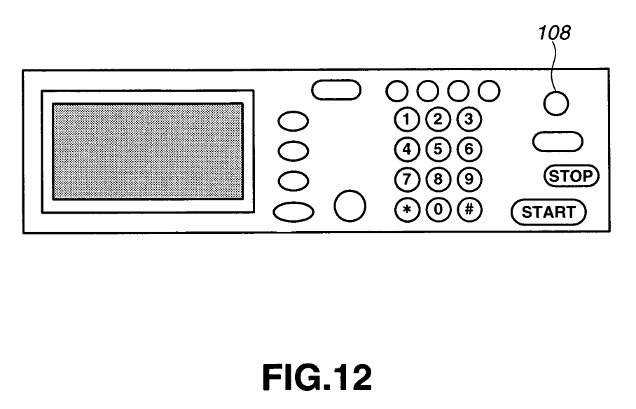

In Example 3, the operation of the multifunctional device 1 with the visually-impaired person dedicated terminal 50 disposed being operated by the visually-impaired person was described. In addition, it may be configured such that a visually-impaired person button 108 is disposed on the input device (operation button) of the operation panel 10 as shown in, for example, FIG. 12 and the execution of the print job (e.g., a print job from an unshown network) by a person other than the operator of the operation panel 10 is prohibited when the button is pushed. In that case, the visually-impaired person button 108 on the operation panel 10 is pushed, it is detected by the status detection section 16 that the visually-impaired person is operating, and the execution of the print job by a person other than the operator of the operation panel 10 is prohibited. At that time, the operation method of the operation panel 10 is guided by voice output from the voice output section 13.

In Example 3 described above, the visually-impaired person dedicated terminal 50 is disposed in addition to the control processing in Example 1, and it is detected by the status detection section 16 that the visually-impaired person is operating. Therefore, the execution of the print job by a person other than the visually-impaired person is prohibited and the operation method is voice guided. Thus, it is conveniently used by the visually-impaired persons, and convenience can be improved.

It was described in the above example that the image processing device according to the present invention was applied to the multifunctional device 1. But, it may be configured so that the method for controlling this image processing device is executed by a control program installed in the multifunctional device 1.

The image processing device according to the present invention is not limited to the multifunctional device but can also be applied to general image processing devices such as printers, facsimiles, copy machines and the like.

The present invention is not limited to the examples above described and shown in the drawings, and various modifications may be made without deviating from the spirit and scope of the invention. For example, the display control processing by the multifunctional device 1 applying the image processing device according to the present invention was described in Examples 1 to 3, but all or part of the embodiments of Examples 1 to 3 may be combined to practice.

The image processing device and its control method and program of the present invention can be applied to general image processing devices such as printers, facsimiles, copy machines and multifunctional devices. Because a universal design was specially taken into consideration, the present invention can be used effectively in public places where a variety (difference in age, sex and race, handicapped or not) of users are present.

The entire disclosure of Japanese Patent Application No. 2004-268445 filed on Sep. 15, 2004 including specification, claims, drawings and abstract is incorporated herein by reference in its entirety.

What is claimed is:

1. An image processing device for executing prescribed processing according to a key operation on an operation panel, comprising:
an operating state detector which detects an operating state of the device;
a key operation detector which detects the key operation on the operation panel; and
a notifying unit which notifies the operation state of the device detected by the operating state detector according to a detection output by the key operation detector.

2. The image processing device according to claim 1, wherein:
the operating state detector detects whether the operating state of the device is in a power saving mode; and
the notifying unit is provided with a voice notifying unit which performs voice guidance for indicating that the device is in the power saving mode in response to the key operation of any keys on the operation panel by the key operation detector when it is detected by the operating state detector that the operating state of the device is in the power saving mode.

3. The image processing device according to claim 2, wherein the voice guidance given by the voice notifying unit includes voice guidance for guiding an operation of canceling the power saving mode.

4. The image processing device according to claim 1, wherein:
the operating state detector detects whether the operating state of the device is in an autoprint state by a print permit timer; and
the notifying unit is provided with a display which displays a remaining time of the print permit timer when it is detected by the operating state detector that the operating state of the device is in the autoprint state by the print permit timer.

5. The image processing device according to claim 1, wherein:
the operating state detector detects whether the operating state of the device is in an autoprint state by the print permit timer; and
the notifying unit is provided with a voice notifying unit which performs voice guidance for indicating the autoprint state and the remaining time of the print permit timer when it is detected by the operating state detector that the operating state of the device is in the autoprint state by the print permit timer.

6. The image processing device according to claim 4, further comprising a reset unit which resets a timer value of the print permit timer.

7. The image processing device according to claim 1, wherein:
the operating state detector detects whether the operating state of the device is in a voice guidance state; and
the notifying unit is provided with a voice notifying unit which performs voice guidance of a key operation on the operation panel when it is detected by the operating state detector that the operating state of the device is in the voice guidance state.

8. The image processing device according to claim 7, further comprising a prohibition unit which prohibits a paper ejection processing based on a print instruction from a person other than an operator of the operation panel when it is detected by the operating state detector that the device is in the voice guidance state.

9. The image processing device according to claim 7, wherein:
the key operation detector is provided with a specified key operation detector which detects the key operation of a particular key on the operation panel; and
the operating state detector detects that the operating state of the device is in the voice guidance state when the operation of the particular key is detected by the particular key operation detector.

10. The image processing device according to claim 1, further comprising:
a visually-impaired person dedicated terminal for visually-impaired persons only;
a visually-impaired person dedicated terminal operation detector which detects the operation of the visually-impaired person dedicated terminal; and
an operation panel prohibition unit which prohibits input from the operation panel, wherein:
the operating state detector detects that the operating state of the device is in a voice guidance state when it is detected by the visually-impaired person dedicated terminal operation detector that the visually-impaired person dedicated terminal is operated; and
the operation panel prohibition unit prohibits input from the operation panel when it is detected by the operating state detector that the device is in the voice guidance state.

11. The image processing device according to claim 1, further comprising:
a visually-impaired persons dedicated terminal for visually-impaired persons only;
a visually-impaired person dedicated terminal operation detector which detects the operation of the visually-impaired person dedicated terminal; and
a prohibition unit which prohibits a paper ejection processing according to a print instruction by a person other than an operator of the visually-impaired person dedicated terminal, wherein:
the operating state detector detects that the operating state of the device is in a voice guidance state when the operation of the visually-impaired person dedicated terminal is detected by the visually-impaired person dedicated terminal operation detector; and
the prohibition unit prohibits the paper ejection processing according to the print instruction by a person other than the operator of the visually-impaired person dedicated terminal when it is detected by the operating state detector that the device is in the voice guidance state.

12. A control method for an image processing device to perform prescribed processing according to a key operation on an operation panel, comprising:
detecting an operating state of the device by an operating state detecting means;
detecting the key operation on the operation panel by a key operation detecting means; and
notifying the operating state of the device detected by the operating state detecting means based on a detection output from the key operation detecting means by a notifying means.

13. A control program to cause a computer to execute processing of an image processing device, which executes prescribed processing according to a key operation on an operation panel, comprising:
an operating state detecting step for detecting an operating state of the device;
a key operation detecting step for detecting the key operation on the operation panel; and
a notifying step for notifying the operating state of the device detected in the operating state detecting step according to a detection output by the key operation detecting step.
